(19) United States
(12) Patent Application Publication
(10) Pub. No.: US 2009/0287752 A1
(43) Pub. Date: Nov. 19, 2009

(54) RECORDING/REPRODUCING APPARATUS AND INFORMATION PROCESSING METHOD

(75) Inventor: Masanari YOSHIDA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/418,679

(22) Filed: Apr. 6, 2009

(30) Foreign Application Priority Data
May 15, 2008 (JP) 2008-128642

(51) Int. Cl. G06F 17/30; G06F 3/00

(52) U.S. Cl. 707/206; 710/5; 707/200; 707/E17.005

(57) ABSTRACT

A recording/reproducing apparatus is capable of searching a file at high speed without an increase in number of times of rewriting the data on an external storage medium. The recording/reproducing apparatus includes: an input/output unit for receiving data from and sending data to an external storage medium and a storage unit for accumulating the data. The apparatus also includes a control unit for reading out a file system for controlling audio/video data. The audio/vide data has been recorded on the external storage medium from the external storage medium and then accumulating the file system in the storage unit through the input/output unit. The apparatus further includes a data base control unit for constructing a database on the basis of attribute information of the audio/video data contained in a file system accumulated in the storage unit and deleting data accumulated in the database at the time of removal of the external storage medium.

### BACKGROUND OF THE INVENTION

1. Field of the Invention

The present invention relates to a recording/reproducing apparatus and an information processing method, specifically technology for facilitating search for data recorded on an external storage medium.

2. Description of the Related Art

Video cameras and recording/reproducing apparatuses with built-in cameras have been designed to record audio/video data (hereinafter referred to as A/V data) obtained by filming subjects in an external storage medium including a flash memory or the like. The external storage medium on which the A/V data has been recorded is connected to the recording/reproducing apparatus which may be called an editing machine or the like. Therefore, A/V data filmed by the recording/reproducing apparatus with a built-in camera can be edited in such an apparatus.

In general, a file system is employed for the management of data recorded on an external storage medium. The term “file system” indicates a structuralized set of files and makes them easy to be accessed by unified operation, managing the relationship between the files and the external storage medium while allowing the user to obtain the namespace of these files.

As a structure for managing the namespace efficiently, a tree structure using a root directory as an origin has been employed in many cases. In this case, nodes of the tree structure correspond to directories and leaf nodes thereof correspond to files. In such a tree structure, the position of each file is uniquely determined by the path from the root directory to the file. Furthermore, although files do not originally have addresses in the memory space of an external storage medium, the files may be mapped in the memory space in advance to allow the user to access them through the respective pointers.

FIG. 1 shows the outline of a file system. In a file system Fs11 shown in FIG. 1, if a request for access to a certain file is input into an interface part 101 of the file system Fs11, then the request is transmitted to a file management unit 102. The request for access to the file is performed by specifying as a pointer an identifier, such as a file ID previously assigned to the file.

The file management unit 102 converts a logical address on a memory space mapped by the file ID specified as a pointer into a physical address in the external storage medium (not shown). Subsequently, the file management unit 102 carries out a process of accessing an address in the external storage medium, which has been assigned by a physical address, and reading a specified file. In such a file system, typically, full text retrieval is performed by sequential-scanning search (sequential retrieval).

The recording/reproducing apparatus attached with the external storage medium also performs a file search using the file system Fs11. In other words, the file system Fs11 is accessed every time the search is performed. Therefore, the file system Fs11 in the external storage medium is read to the main memory or the like on the recording/reproducing apparatus at the time of attaching the external storage medium to the recording/reproducing apparatus. When searching, a file system Fs11′ on the main memory is accessed.

Furthermore, at the time of removing (unmounting) the external recording medium, the file system Fs11′ in the main memory of the recording/reproducing apparatus is written back to the external storage medium. By performing such a process, the contents of change added to the file system Fs11′ in connection with an editing operation or the like will also reflect on the file system Fs11 in the external storage medium.

Referring now to FIG. 2, there is a flowchart that illustrates an exemplary process performed by a recording/reproducing apparatus when an external storage medium is attached thereto and removed therefrom.

First, if the mounting of the external storage medium is detected on the recording/reproducing apparatus (Step S21), then the file system Fs11 in the external storage medium is read into the main memory of the recording/reproducing apparatus (Step S22). Subsequently, it is determined whether the removal of the external storage medium is detected (Step S23). Until it is detected, it is determined whether the recording or updating of audio/video (A/V) data is accepted (Step S24). If the recording or updating of A/V data is not accepted, then the determination in Step S24 is repeated.

If the recording or updating of A/V data is accepted, then the process of recording or updating the A/V data on the external storage medium (Step S25) is performed. The contents thereof being modified in connection with the recording or updating are then reflected on a file system Fs11′ on the main memory of the recording/reproducing apparatus (Step S26). At the time of detecting the removal of the external storage medium at Step S23, the file system Fs11′ on the main memory is written back to the external storage medium (Step S17).

FIG. 3 indicates the relationship between a recording/reproducing apparatus 100 and an external storage medium 200. In the external storage medium 200 represented on the lower part of FIG. 3, A/V data Dt11 and a file system Fs11 including both a logic/physical address conversion table Tb11 and attribute information Md11 are recorded. Among them, the file system Fs11 including the logic/physical address conversion table Tb11 and the attribute information Md11 is read (loaded) in a main memory on the recording/reproducing apparatus 100 at the time of attaching the external storage medium 200 to the recording/reproducing apparatus 100.

Furthermore, in the recording/reproducing apparatus 100, if a request for access to a file is input into an interface unit 101 as a pointer access, the logic/physical address conversion table Tb11′ and attribute information Md11′ in the file system are updated according to the contents of the request. Thus, both the logic/physical address conversion table Tb11′ and the attribute information Md11′ which have been changed in this way are rewritten from the main memory to the external storage medium 200 at the time of removing the external storage medium 200 from the recording/reproducing apparatus 100.

While the amount of A/V data recorded on the external storage medium 200 by the recording/reproducing apparatus with built-in camera is a little, the search using the file system Fs11 (Fs11′) will be carried out properly. However, if the amount of A/V data recordable in the external storage medium 200 increases remarkably by an increase in capacity of the external storage medium 200, or the like, it is assumed that the search using the file system Fs11 will take too much time.

If search for a large volume of data is required, a database is used in many cases. FIG. 4 schematically illustrates the database. In database Db11, data is not structured but recorded in a byte stream format. Subsequently, a request for access to the data is input as an SQL sentence into a database control unit 110 (also referred to as a DB control unit) through an interface unit 101, and the corresponding data is then extracted by the DB control unit 110. In the database Db11, data is sorted at the time of recording data and the process for making an index is then performed. Therefore, time required for searching and data extraction can be shortened remarkably, as compared with the use of a file system without such a process.

For this reason, efforts of employing database Db11 in devices for handing A/V data have been also made. For example, Japanese Published Patent Application No. 2006-190075 describes that the attribute information of data being recorded in a magnetic table is recorded in a table formant on MIC (Memory In Cassette) to enable a search with SQL.

### SUMMARY OF THE INVENTION

In the apparatus having the file system Fs11′ as described above, it is assumed that a recording/reproducing apparatus 100 and an external storage medium 200 may be configured as shown in FIG. 5 when using a database Db11 subordinately. In the external storage medium 200, the information of database Db11 is also accumulated in addition to A/V data Dt11 and a file system Fs11. Subsequently, among them, when the external storage medium 200 is attached to the recording/reproducing apparatus 100, the data of a logic/physical address conversion table Tb11 and attribute information Md11, which are contained in the file system Fs11, and the data of database Db11 are uploaded on the main memory of the recording/reproducing apparatus 100.

While the external storage medium 2000 is being attached to the apparatus, requests for adding, updating, and deleting files can be input by SQL through the interface unit 101 of the file system and then both the logic/physical address conversion table Tb11′ and the attribute information Md11′ are changed according to any of these processes. Furthermore, the updated attribute information Md11′ is converted into byte-stream format data by a database control unit 110 and then accumulated in the database Db11. At this time, sorting of data and creation of an index are also carried out. In the recording/reproducing apparatus 100 as constructed as described above, when searching data, a request for file search by SQL through the interface unit 120 of the database Db11 is input and the data corresponding to inquiry through SQL sentence is then extracted.

When the external storage medium 200 is removed from the recording/reproducing apparatus 100, the data of database Db11′ is written back to the external storage medium 200 together with the file system Fs11′ temporarily stored on the main memory of the recording/reproducing apparatus 100.

However, in such an operation form, the data of database Db11 is also uploaded to the recording/reproducing apparatus 100 at the time of mounting the external storage medium 200 on the apparatus 100. In general, since the volume of data in the database Db11 is often higher than that of the file system Fs11, the time required for upload may be prolonged. In other words, there is an increase in processing time at the time of mounting the external storage medium 200 on the apparatus 100.

Likewise, data of database Db11′ is read to the external storage medium 200 at the time of removing the external storage medium 200. Thus, it also leads to an increase in processing time at the time of unmounting.

In the database D11′, furthermore, a so-called journaling process is often carried out for periodically backing up the intermediate results to increase the data maintainability. When this function is being enabled, log information is allowed to be suitably written in the external storage medium 200. Thus, the number of times of rewriting the external storage medium 200 will increase inevitably.

However, it is known that the external storage medium 200, such as a flash memory, has low durability with respect to the number of times of rewriting the data thereon. Flash memories have been commonly said to withstand almost 100,000 times of rewriting in the case of single-level cell (SLC) type and almost 10,000 times in the case of multi-level cell (MLC) type. For this reason, when rewriting the data on the external storage medium 200 is performed frequently, the life of the external storage medium 200 will be shortened. Even if the use of the function of journaling is restricted, a large volume of database data can be also read and written on the external storage medium 200 when mounting or unmounting. When such an operation is performed, the external storage medium 2000 may be facilitated to be exhausted.

The present invention has been made in consideration of the aforementioned circumstances and intends to provide a recording/reproducing apparatus which is capable of searching a file at high speed without increasing the number of times of rewriting the data on an external storage medium and also provide an information processing method using such an apparatus.

According to any embodiments of the present invention, a recording/reproducing apparatus and an information processing method are configured to read a file system for managing video data currently recorded on the external storage medium and then construct a database based on the attribute information of the video data. Furthermore, data accumulated in the database can be deleted when removing the external storage.

Accordingly, file search can be performed using a database engine.

Furthermore, since data accumulated in the database is deleted at the time of removal of the external storage medium, the data may not be transmitted from the database to the external storage medium.

According to the present invention, since search of a file is performed using database engine, a file search can be performed at high speed.

Furthermore, since the data of the database is not stored in the external storage medium, the number of times of rewriting the data on the external storage medium can be suppressed to the minimum.

### BRIEF DESCRIPTION OF THE DRAWINGS

FIG. 1 is an explanatory diagram illustrating an exemplary configuration of a related-art file system.

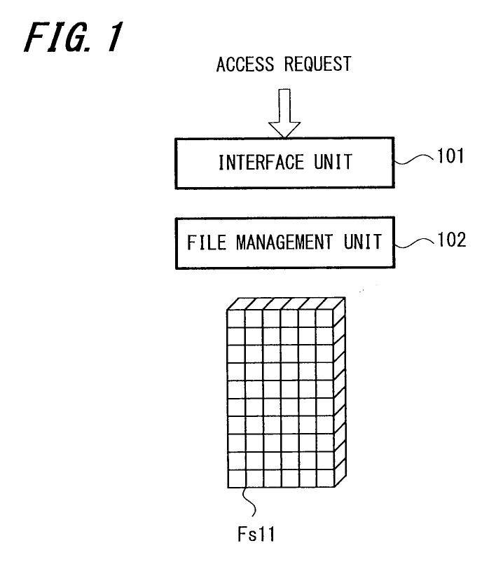

FIG. 2 is a flowchart illustrating an exemplary process carried out by a related-art recording/reproducing apparatus.

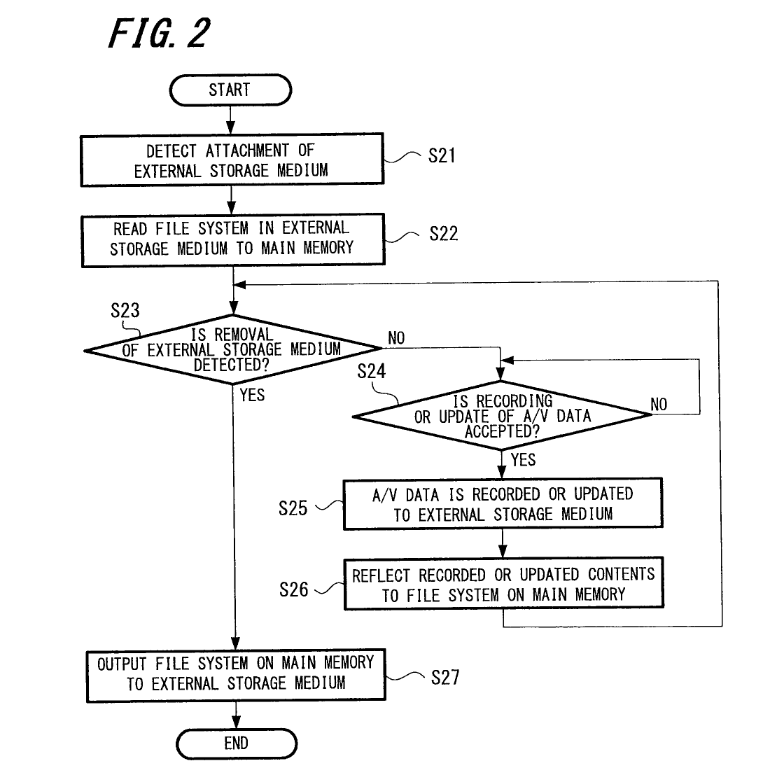

FIG. 3 is an explanatory diagram illustrating an exemplary relationship between a related-art recording/reproducing apparatus and an external storage medium.

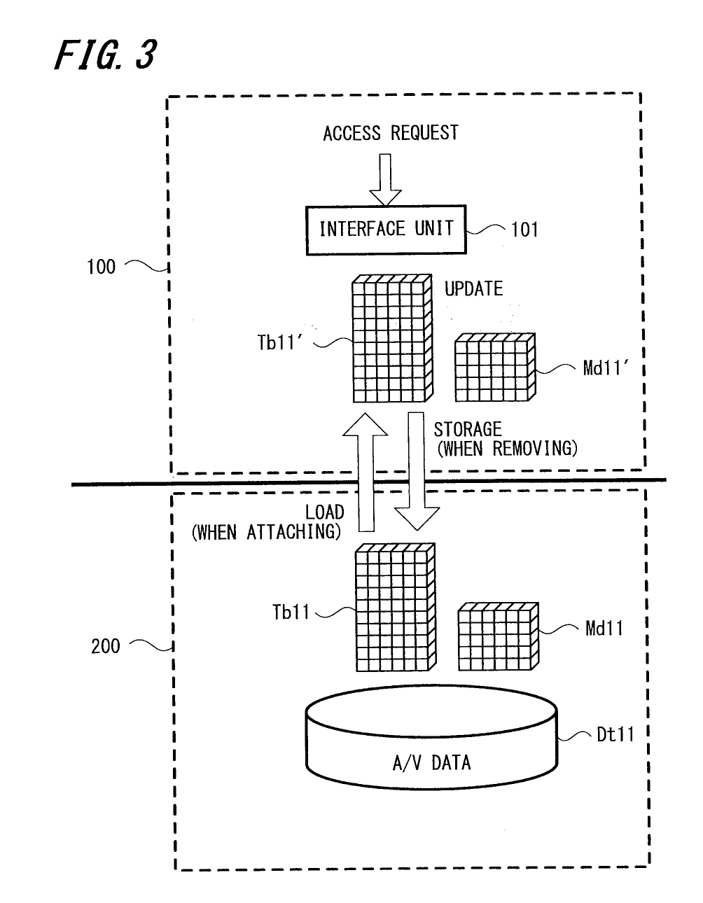

FIG. 4 is an explanatory diagram illustrating an exemplary construction of a related-art database.

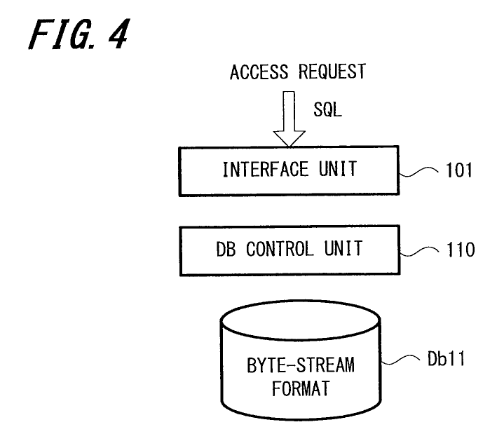

FIG. 5 is an explanatory diagram illustrating an exemplary relationship between a recording/reproducing apparatus and an external storage medium when introducing a related-art database.

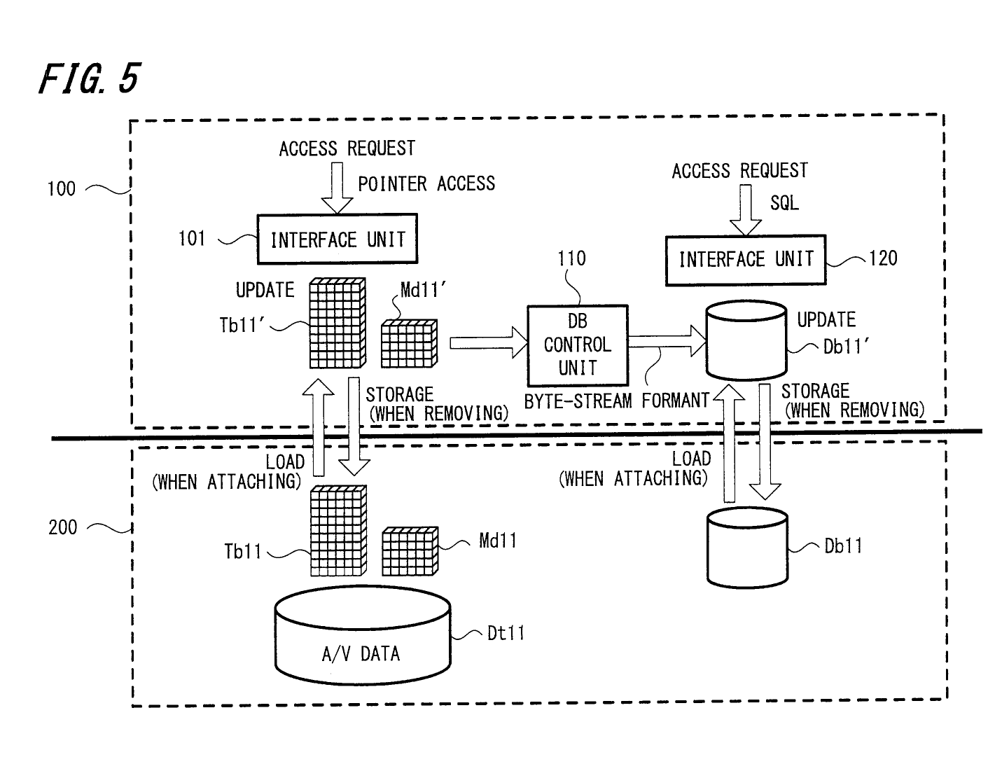

FIG. 6 is a block diagram illustrating an exemplary internal configuration of a system according to an embodiment of the present invention.

FIG. 7 is an explanatory diagram illustrating an example of the relationship between a recording/reproducing apparatus and an external reproducing apparatus according to an embodiment of the present invention.

FIG. 8 is a flowchart illustrating an exemplary process carried out by a recording/reproducing apparatus according to an embodiment of the present invention.

### DESCRIPTION OF THE PREFERRED EMBODIMENTS

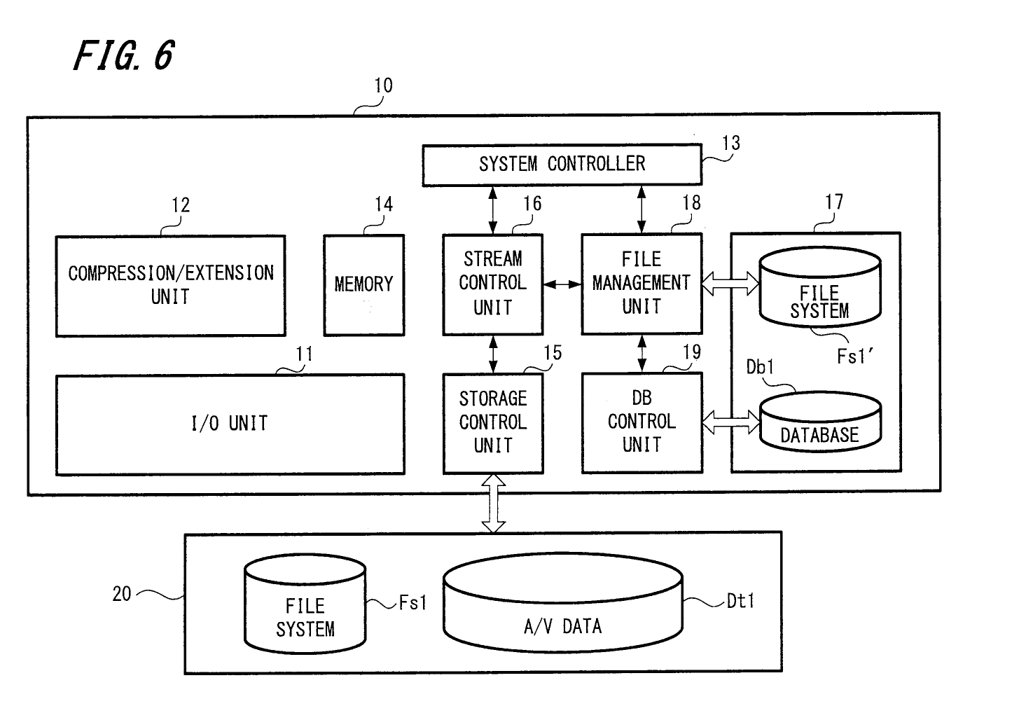

Hereinafter, a recording/reproducing apparatus according to an embodiment of the present invention will be described with reference to FIG. 6 to FIG. 8. In the embodiment shown in the figures, the recording/reproducing apparatus is applied to an editing system. This editing system receives A/V data shot and recorded by the recording/reproducing apparatus through an external storage medium, such as a flash memory, and then edits and processes the received A/V data. FIG. 6 is a block diagram illustrating exemplary configurations of a recording/reproducing apparatus 10 and an external storage medium 20 which constitute an editing system.

The external storage medium 20 stores both A/V data Dt1 filmed by a recording/reproducing apparatus or the like with a built-in camera and a file system Fs1 for managing such A/V data Dt1.

Next, the configuration of the recording/reproducing apparatus 10 will be described. The recording/reproducing apparatus 10 includes an I/O unit 11, a compression/extension unit 12, a system controller 13 as a control unit, and a memory 14. The I/O unit 11 introduces A/V data Dt1, a control signal, or the like output from an external device such as the external storage medium 20 or an imaging apparatus (not shown) into the recording/reproducing apparatus 10. In addition, the I/O unit 11 outputs A/V data sent from a compression/extension unit 12 described later to an external device such as a display device (not shown).

For recording the A/V data Dt1 transmitted from an imaging apparatus or the like in the external storage medium 20, the compression/extension unit 12 compresses the A/V data Dt1 input from the I/O unit 11 using a predetermined compression format under the control of a system controller 13. In addition, if the A/V data Dt1 recorded on the external storage medium is read and regenerated, the A/V data read based on the A/V data Dt1 is expanded and then output to the I/O unit 11.

The system controller 13 includes a central processing unit (CPU) and the like and controls each part of the recording/reproducing apparatus 10. Specifically, the system controller 13 performs, for example, a process of reading a file system Fs1 from the external storage medium 20 and storing the file system Fs1 in a storage unit 17. The memory 14 stores data which is temporarily generated when the system controller 13 carries out any process.

In addition, the recording/reproducing apparatus 10 includes a storage control unit 15, a stream control unit 16, and a storage unit 17 as a main memory, a file management unit 18, and a DB control unit 19.

The storage control unit 15 controls the process for read and write of data on the external storage medium 20. A stream control unit 16 controls processes in the compression/extension unit 12 and the storage control unit 15. The storage unit 17 includes a semiconductor memory or the like, storing both the file system Fs1 and the database Db1 read from the external storage medium 20. In this example, the file system Fs1 accumulated in the storage unit 17 is referred to as a file system Fs1′.

The database Db1 offers a mechanism for carrying out file search by SQL but not by sequential-scanning search. The items of a table are set to arbitrary items by the user at the time of initialization. The items to be selected are those of attribute information which the user want to use as keys when searching, such as “file name”, “maker”, “creation date”, and “recording format”. In this embodiment, furthermore, any journaling function is not used.

A file management unit 18 controls the read and write of data on the file system Fs1′. In other words, the file management unit 18 performs the addition of A/V data Dt1 through the I/O unit 11 and also performs the addition, update, or deletion of information from the file system Fs1′ when the instruction of updating or deleting a file through an operation input unit or the like (not shown).

The DB control unit 19 generates a table using items. Here, the items are previously defined as those to be used for the database Db1 among the attribute information of the file system Fs1′ which has been read on the storage unit 17. Then, the DB control unit 19 performs the process for converting the attribute information of the file system Fs1′ into a byte stream format and writing the attribute information in the table. In addition, when the user inputs a key for search through the operation input unit or the like, the DB control unit 19 extracts data having a key corresponding to the input key from the database Db1. Specifically, the input key is converted into the SELECT statement of SQL and the data is then extracted using the SELECT sentence.

Further, when the contents of the file system Fs1′ are changed along with the recording, updating, or deleting of A/V data Dt1, the DB control unit 19 carries out the process for converts the contents related to the database Db1′ among those being changed into the byte-stream formatted data. Then it carries out the process for writing such data in the database Db1′. At this time, a process, such as one for sorting data or one for creating an index thereof, is also performed.

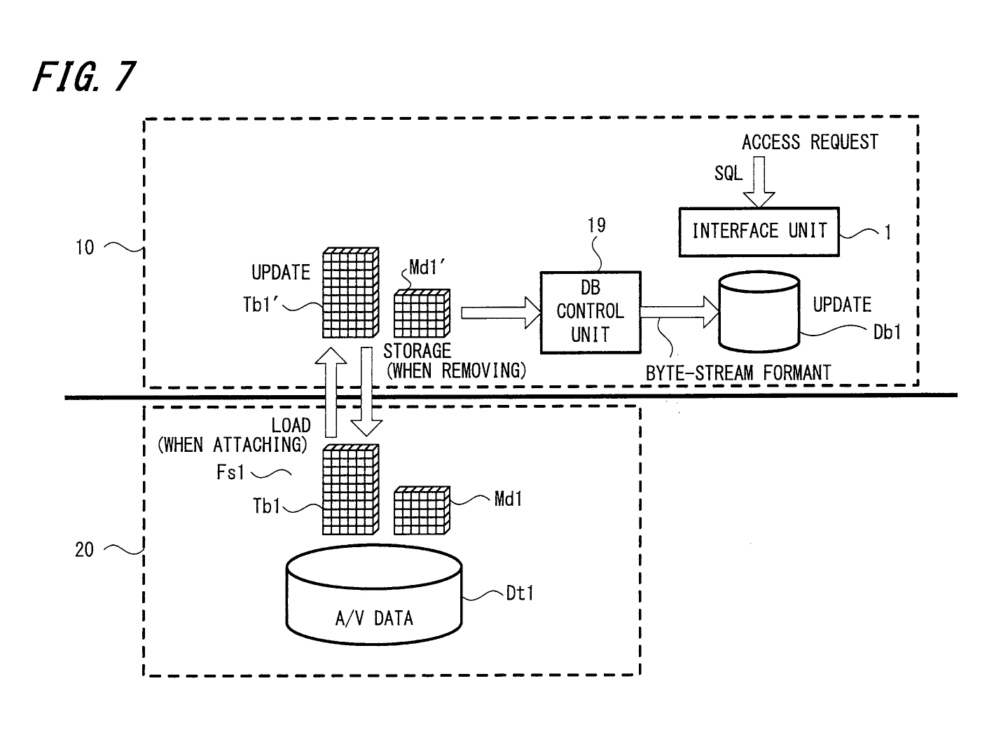

Referring now to FIG. 7, an example of data exchanged between a recording/reproducing apparatus 10 and an external storage medium 20 will be described. In this case, the external storage medium 20 stores A/V data Dt1, a logic/physical address conversion table Tb1 as a file system Fs1, and attribute information Md1. Among them, both the logic/physical address conversion table Tb1 in the file system Fs1 and the attribute information Md1 are uploaded on the storage unit 17 of the recording/reproducing apparatus 10 when the external recording medium is mounted thereon.

While the external storage medium 200 is being attached to the recording/reproducing apparatus 10, the attribute information Md11′ and the logic/physical address conversion table Tb1 are changed depending on requests for adding, updating, and deleting files to be input through an interface unit 1. In addition, the updated attribute information Md11′ is converted into byte-stream formatted data and then accumulated in the database Db1. At this time, a date-sorting process and an index-creating process are also performed.

When the external storage medium 20 is removed from the recording/reproducing apparatus 10, only the file system Fs1′ temporarily stored in the storage unit 17 of the recording/reproducing apparatus 10 is saved in the external storage medium 20.

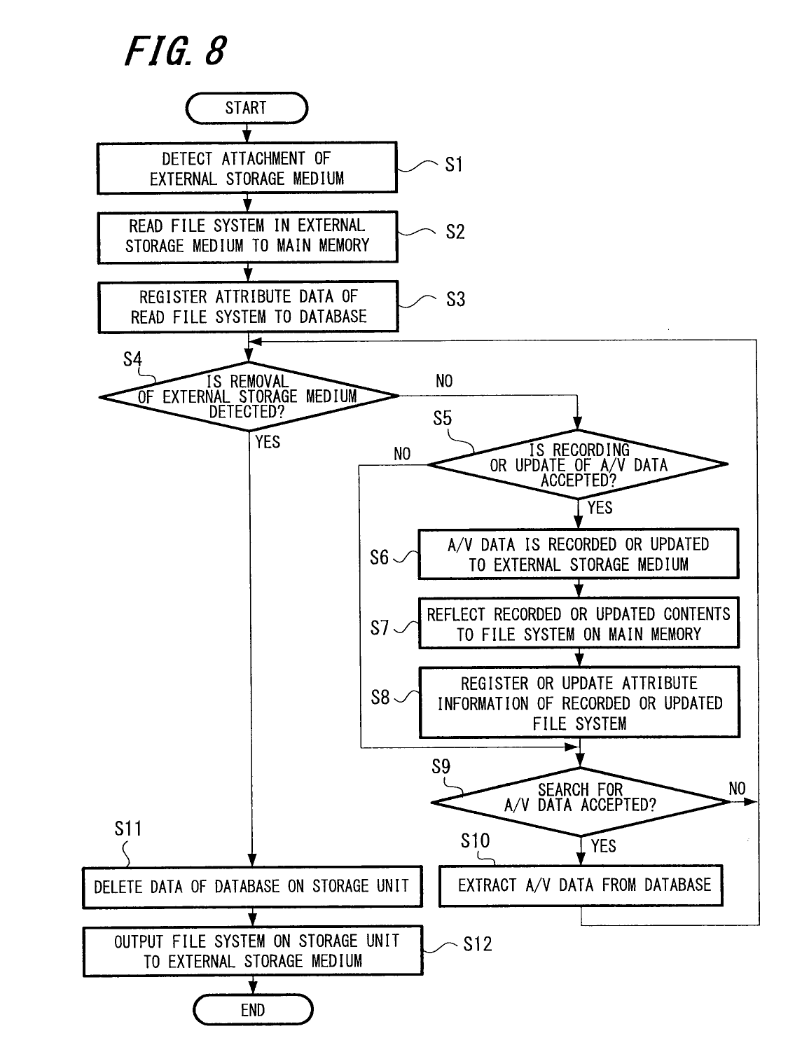

Next, an example of the process in the recording/reproducing apparatus 10 of the present embodiment will be described with reference to the flowchart of FIG. 8. First, if the recording/reproducing apparatus 10 detects that the external storage medium 20 is mounted (Step S1), then the file system Fs1 is read from the eternal storage medium 20 to the storage unit 17 of the recording/reproducing apparatus 10 (Step S2). Subsequently, among the attribute information managed in the file system Fs1, items previously specified by the user are registered as those of a table of the database Db1 (Step S3).

Next, it is determined whether the removal of the external storage medium 20 is detected (Step S4). Until it is detected, it is determined whether the recording (addition) or update (change or delete) of A/V data Dt1 is accepted (Step S5). If the recording or update of the A/V data Dt1 is not accepted, then the process returns to Step S4 and then proceeds therefrom.

If the recording or update of the A/V data Dt1 is accepted, the process for recording the A/V data Dt1 in the external storage medium 20 or the process for updating the A/V data Dt1 is performed (Step S6). The contents of the data being changed by the recording or updating process is reflected on the file system Fs11′ on the storage unit 17 of the recording/reproducing apparatus 10 (Step S7). Subsequently, the contents registered or updated with respect to the attribute information Md1′ of the file system Fs1′ are also registered or updated in the database Db1 (Step S8). In other words, the file system Fs1′ and the database Db1, which are stored in the storage unit 17, can be updated synchronously.

Next, it is determined whether a request for search of A/V data is input through the interface unit 1 (see FIG. 7) (Step S9). If the request for search of A/V data is input, then the corresponding A/V data is extracted from the database Db1 (see FIG. 6 and FIG. 7). If the search request is not accepted, then the process returns to Step S4 and proceeds therefrom.

Furthermore, at the time of detecting removal of the external storage medium 20 at Step S4, the data of the database Db1′ on the storage unit 17 is deleted (Step S11) and the file system Fs1′ is then stored in the external storage medium 20.

According to the above embodiment, the database Db1 having the items specified by the user as a table is constructed on the storage unit 17 of the recording/reproducing apparatus 10. Therefore, using the attribute information specified as items of the database Db1 as a key, a file can be easily searched.

In this case, the search is performed using the engine of the database Db1, so that time required for the search can be considerably shortened as compared with the search with a file system.

In this case, furthermore, even if the amount of A/V data Dt1 accumulated in the external storage medium 20 is extremely large, the search can be performed using the database engine at high speed.

In this case, furthermore, the database Db1 constructed in the storage unit 17 of the recording/reproducing apparatus 10 includes only items specified by the user, so that the database Db1 will not use resources of the recording/reproducing apparatus 10. Therefore, the resources of the recording/reproducing apparatus 10 can be effectively used.

Furthermore, according to the above embodiment, time required for the mount can be prevented from increasing because only the table of database Db1 is constructed when the external storage medium 20 is attached to the recording/reproducing apparatus 10.

Furthermore, when the external storage medium 20 is removed from the recording/reproducing apparatus 10, the deletion of data from the database Db1 and the storage of the file system Fs1′ therein are only performed. Thus, time required for unmounting may not be affected.

Furthermore, according to the above embodiment, a journaling function is not used during the construction of database Db1. Thus, the number of times of rewriting the data on the external storage medium 20 can be kept to the minimum necessary.

Furthermore, according to the above embodiment, the database Db1 is constructed when the external storage medium 20 is attached. The data accumulated in the database Db1 is then deleted at the time of removal of the external storage medium 20. In other words, there is no need of storing the database Db1 in the external storage medium 20. Thus, the external storage medium 20 can be prevented from redundant rewriting.

In this case, the database Db1 is automatically constructed at the time of attaching the external storage medium 20, so that the recording/reproducing apparatus 10 can be provided with compatibility with a device free of database engine. Therefore, a system with high expandability can be constructed.

Furthermore, the above embodiment has been described with reference to the exemplary recording/reproducing apparatus as one for reading out A/V data Dt1 accumulated in the external storage medium 20. Alternatively, it may be applied to any of other apparatuses, such as a simple viewer.

The present application contains subject matter related to that disclosed in Japanese Priority Patent Application JP 2008-128642 filed in the Japan Patent Office on May 15, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording/reproducing apparatus, comprising:
an input/output unit for receiving data from and sending data to an external storage medium;
a storage unit for accumulating the data;
a control unit for reading out a file system for controlling audio/video data that has been recorded on the external storage medium from the external storage medium and then accumulating the file system in the storage unit through the input/output unit; and
a data base control unit for constructing a database on the basis of attribute information of the audio/video data contained in a file system accumulated in the storage unit and deleting data accumulated in the database at the time of removal of the external storage medium.

2. The recording/reproducing apparatus according to claim 1, wherein
the database control unit generates a table by extracting an item specified by a user from items of the attribute information contained in the file system, and
the database is constructed by converting the attribute information into data in format that can be managed by the database and storing the converted data in the table.

3. The recording/reproducing apparatus according to claim 2, wherein
the database control unit performs a process for constructing the data base when the external storage medium is attached to the recording/reproducing apparatus.

4. The recording/reproducing apparatus according to claim 3, wherein
an interface unit for receiving a request for access to a film managed by the file system accumulated in the storage unit; and
a file management unit for updating the contents of the file system accumulated in the storage unit according to the access request input through the interface unit, wherein
the file management unit outputs the file system accumulated in the storage unit to the external storage medium when the external storage medium is removed from the recording/reproducing apparatus.

5. The recording/reproducing apparatus according to claim 4, wherein
the database control unit updates the contents of the database in synchronization with an update of the file system by the file management unit.

6. An information processing method, comprising the steps of:
reading a file system for managing audio/video data that has been stored in the external storage medium from the external storage medium;
constructing a database on the basis of attribute information of the audio/video data contained in the read file system; and
deleting data accumulated in the database when removing the external storage medium.
